(19) United States
(12) Patent Application Publication
(10) Pub. No.: US 2016/0092646 A1
(43) Pub. Date: Mar. 31, 2016

(54) REMOTE MEDICAL CONSULTATION AND DIAGNOSIS

(71) Applicants: John S. Rinkacs, North Attleboro, MA (US); Tobias Barker, Sharon, MA (US); James Murray, Littleton, MA (US)

(72) Inventors: John S. Rinkacs, North Attleboro, MA (US); Tobias Barker, Sharon, MA (US); James Murray, Littleton, MA (US)

(21) Appl. No.: 14/868,731

(22) Filed: Sep. 29, 2015

Related U.S. Application Data
(60) Provisional application No. 62/056,795, filed on Sep. 29, 2014.

(51) Int. Cl. G06F 19/00

(52) U.S. Cl. CPC G06F 19/3425; G06F 19/3456; G06F 19/322

(57) ABSTRACT

A method for providing remote medical consultation and diagnosis, the method including a patient visiting a service facility where a secondary healthcare provider is located, establishing a teleconferencing session between a first teleconferencing station located in the service facility and a second teleconferencing station located in a provider facility that is remote from the service facility, a primary healthcare provider being present at the provider facility, and the primary healthcare provider performing an examination on the patient using audio and video that are captured at the first teleconferencing station and transmitted to the second teleconferencing station.

### CROSS-REFERENCE TO RELATED APPLICATIONS

This application claims priority to and the benefit of U.S. Provisional Patent Application Ser. No. 62/056,795, filed Sep. 29, 2014, the disclosure of which is hereby incorporated by reference herein it its entirety.

### FIELD OF THE DISCLOSURE

Embodiments of the present disclosure relate generally to the field of medical consultation and diagnosis, and more particularly to a method and system for facilitating remote medical consultation and diagnosis.

### BACKGROUND OF THE DISCLOSURE

Traditionally, medical consultation and diagnosis have been performed through face-to-face, in-person interactions between patients and qualified healthcare professionals. This method of consultation and diagnosis generally requires a patient to travel to a clinic or a hospital where a healthcare professional is located. In some cases, such as if the patient lives in a remote area or in an area that is underserved by qualified healthcare professionals, the patient may be required to travel a great distance in order to obtain a consultation and diagnosis. This situation can present a significant inconvenience to some patients and, in the case of patients with impaired mobility, may be prohibitively burdensome. Even in areas where sufficient numbers of qualified healthcare professionals are present, the process of scheduling an in-person appointment with a doctor and then waiting for the appointment can itself be inconvenient and unnecessarily time-consuming, especially if a patient's injury or illness is relatively minor and can be addressed quickly with minimal intervention.

In view of the foregoing, it would be advantageous to provide a method for allowing a patient to obtain a medical consultation and diagnosis from a qualified healthcare professional without requiring the patient and the healthcare professional to be physically present at the same location.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

In one aspect, a method for providing remote medical consultation and diagnosis includes a patient visiting a service facility where a secondary healthcare provider is located, establishing a teleconferencing session between a first teleconferencing station located in the service facility and a second teleconferencing station located in a provider facility that is remote from the service facility, a primary healthcare provider being present at the provider facility, and the primary healthcare provider performing an examination on the patient using audio and video that are captured at the first teleconferencing station and transmitted to the second teleconferencing station.

The secondary healthcare provider may collect intake information from the patient prior to establishing the teleconferencing session. The secondary healthcare provider may measure vital signs of the patient prior to establishing the teleconferencing session. The examination may include the primary healthcare provider instructing the secondary healthcare provider to use examination tools associated with the first teleconferencing station to capture desired video of the patient's anatomy. The captured video may be presented at the first teleconferencing station and at the second teleconferencing station simultaneously. The primary healthcare provider may instruct the secondary healthcare provider to perform a test on the patient at the service facility. The primary healthcare provider may use one or more of measured vital signs of the patient, observations of the patient made during the examination, and results of tests that are performed on the patient by the secondary healthcare provider to render a diagnosis for the patient. The primary healthcare provider may provide the patient with a treatment regimen based on the diagnosis. The primary healthcare provider may provide the patient with a prescription for medication, and the patient filling the prescription at the service facility. The secondary healthcare provider may send a summary of the patient's consultation and diagnosis to a primary care physician of the patient.

In another aspect, a system for providing remote medical consultation and diagnosis includes first and second teleconferencing systems. The first teleconferencing system is located in a service facility where a secondary healthcare provider and a patient are located and includes an examination tool to capture video of the patient's anatomy and a computer processor configured to execute computer instructions to initiate a teleconferencing session between the first teleconferencing system and a second teleconferencing system; receive, from a primary healthcare provider, directions for the secondary healthcare provider to examine the patient using the examination tool; and transmit, to the primary healthcare provider, results of the examination. The second teleconferencing system is located in a provider facility where the primary healthcare provider is located and includes a computer processor configured to execute computer instructions to: display medical records associated with the patient for review by the primary healthcare provider; transmit, per a request from the primary healthcare provider, directions to the secondary healthcare provider to examine the patient; receive, from the secondary healthcare provider, results of the examination; and transmit, to the secondary healthcare provider, a treatment plan based at least in part on the results.

The computer processor of the first teleconferencing system may be further configured to collect intake information from the patient prior to initiating the teleconferencing session. The computer processor of the first teleconferencing system may be further configured to receive vital signs of the patient measured by the secondary healthcare provider prior to establishing the teleconferencing session. The computer processors of the first and second teleconferencing systems may be further configured present the captured video at the first teleconferencing station and at the second teleconferencing station simultaneously. The computer processor of the first teleconferencing system may be further configured further comprising transmitting an instruction from the primary healthcare provider instructing the secondary healthcare provider to perform a test on the patient at the service facility.

In general, various embodiments of the present disclosure provide a method for providing remote medical consultation and diagnosis. An exemplary embodiment of such a method in accordance with the present disclosure may include the steps of a patient visiting a service facility where a secondary healthcare provider is located, establishing a teleconferencing session between a first teleconferencing station located in the service facility and a second teleconferencing station located in a provider facility that is remote from the service facility, a primary healthcare provider being present at the provider facility, and the primary healthcare provider performing an examination on the patient using audio and video that are captured at the first teleconferencing station and transmitted to the second teleconferencing station.

### BRIEF DESCRIPTION OF THE DRAWINGS

By way of example, various embodiments of the disclosed device will now be described, with reference to the accompanying drawings, in which:

FIG. 1 is schematic view illustrating an exemplary teleconferencing system in accordance with the present disclosure;

FIG. 2 is a flow diagram illustrating an exemplary method for providing remote medical consultation and diagnosis in accordance with the present disclosure.

### DETAILED DESCRIPTION

Systems and methods for providing remote medical consultations and diagnoses in accordance with the present disclosure will now be described more fully hereinafter with reference to the accompanying drawings, in which preferred of the method are shown. The systems and methods, however, may be embodied in many different forms and should not be construed as being limited to the embodiments set forth herein. Rather, these embodiments are provided so that this disclosure will be thorough and complete and will fully convey the scope of the methods to those skilled in the art. In the drawings, like numbers refer to like elements throughout unless otherwise noted.

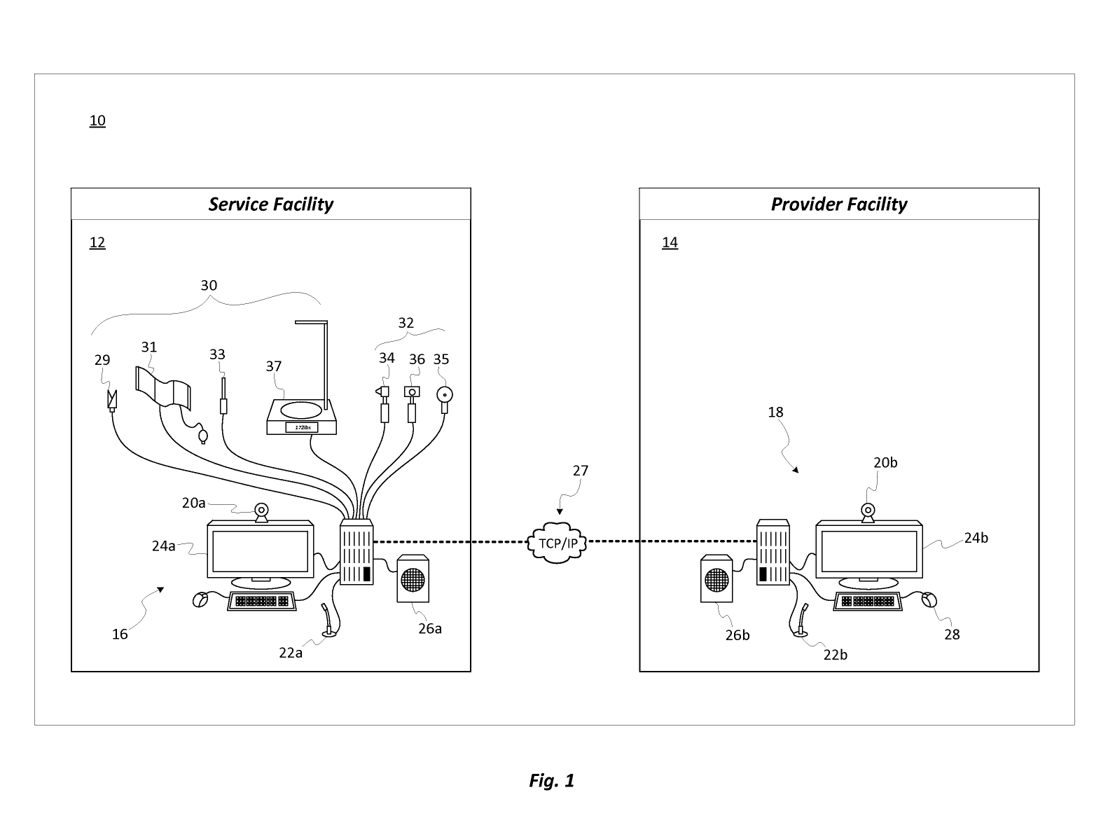

Referring to FIG. 1, a video-conferencing system 10 (hereinafter “the system 10”) for facilitating remote medical consultation and diagnosis in accordance with the present disclosure is shown. The system 10 may include a service facility 12 and a provider facility 14 that are located remote from one another. For example, the service facility 12 and the provider facility 14 may be located in different neighborhoods, in different cities, in different states, or even in different countries. In one non-limiting example, the service facility 12 may be a pharmacy and the provider facility 14 may be a hospital. In another non-limiting example, the service facility 12 and/or the provider facility 14 may be a medical clinic, a community health center, an urgent care facility, or the like.

The provider facility 14 may be an establishment that regularly staffs one or more “primary healthcare providers.” A “primary healthcare provider” is defined herein as a healthcare provider who is qualified (e.g. licensed) to independently render medical diagnoses and to prescribe medications to patients. For example, primary healthcare providers may include, but are not limited to, licensed physicians and licensed nurse practitioners (LNPs).

In contrast to the provider facility 14, the service facility 12 may be an establishment that does not staff, or that staffs a limited number of, primary healthcare providers. Instead, the service facility 12 may normally staff one or more “secondary healthcare providers.” A “secondary healthcare provider” is defined herein as a healthcare provider who is not qualified to independently render medical diagnoses or to prescribe medications to patients, but who is qualified to render basic medical care. For example, secondary healthcare providers may include, but are not limited to, medical assistants, registered nurses, and licensed vocational nurses (LVNs).

The system 10 may further include a first teleconferencing station 16 located in the service facility 12 and a second teleconferencing station 18 located in the provider facility 14. The first teleconferencing station 16 and the second teleconferencing station 18 may include respective cameras 20a, 20b, microphones 22a, 22b, displays 24a, 24b, and speakers 26a, 26b that are configured to facilitate two-way audio/video communication between the first teleconferencing station 16 and the second teleconferencing station 18. Particularly, the first teleconferencing station 16 and the second teleconferencing station 18 may be communicatively coupled to one another via a wired and/or wireless network connection 27, such as via the Internet using transmission control protocol and Internet protocol (TCP/IP) as shown in FIG. 1. Various other network connection arrangements for communicating audio/video data are contemplated and may be additionally or alternatively implemented in the system 10 without departing from the scope of the present disclosure. Such communication arrangements include, but are not limited to, dial-up, Ethernet, token ring, etc. In some embodiments, the network connection 27 may be a secure connection, such as may be achieved through the implementation of a virtual private network (VPN) or other secure connection means.

While the system 10 is illustrated in FIG. 1 as including a single teleconferencing station 16 at the service facility 12 and a single teleconferencing station 18 at the provider facility 18, it is contemplated that one or both of the service facility 12 and the provider facility 18 may include a plurality of teleconferencing stations.

In some embodiments of the system 10, it is contemplated that a primary healthcare provider at the provider facility 14 may have that ability to control, such as through manipulation of an input device 28 (e.g., a mouse, joystick, keyboard, etc.) of the second teleconferencing station 18, the camera 20a of the first teleconferencing station 16. This may be beneficial for allowing the primary healthcare provider to obtain a desired view of a patient at the service facility 12 as further described below.

The first teleconferencing station 16 may further include one or more diagnostic devices 30 that may be adapted to measure various vital signs of patients. The diagnostic devices may include, but are not limited to, a pulse oximeter 29 for measuring a patient's blood oxygen saturation, a sphygmomanometer 31 for measuring a patient's blood pressure, a thermometer 33 for measuring a patient's temperature, and a scale 37 for measuring a patient's weight and height. The diagnostic devices 30 may be analogue or digital, and the measurements obtained from the diagnostic devices 30 may be presented locally, such as on integral displays of the diagnostic devices 30, on the display 24a of the first teleconferencing station 16, on one or more separate displays (not shown) at the service facility 12, and/or may be transmitted via the network connection 27 to the second teleconferencing station 18 for presentation on the display 24b or on one or more separate displays (not shown) at the provider facility 14.

In addition to the diagnostic devices 30, the first teleconferencing station 16 may further include one or more digital examination devices 32 (e.g., video cameras and microphones) that may be specially adapted to capture video or audio of specific portions of a patient's anatomy. For example, such examination devices 32 may include, but are not limited to, a video otoscope 34 that may be adapted to capture digital video of a patient's inner ear, and a video laryngoscope 36 that may be adapted to capture digital video of a patient's throat. The examination devices 32 may further include a digital stethoscope 35 that may be adapted to capture audio of a patient's heart and/or lung sounds during auscultation. The video and audio captured by the examination devices 32 may be presented locally, such as via integral displays or speakers of the examination devices 32, on the display 24a or through the speakers 26a of the first teleconferencing station 16, via one or more separate displays or speakers (not shown) at the service facility 12, and/or may be transmitted via the network connection 27 to the second teleconferencing station 18 for presentation via the display 24b or speakers 26b, or via one or more separate displays or speakers (not shown) at the provider facility 14.

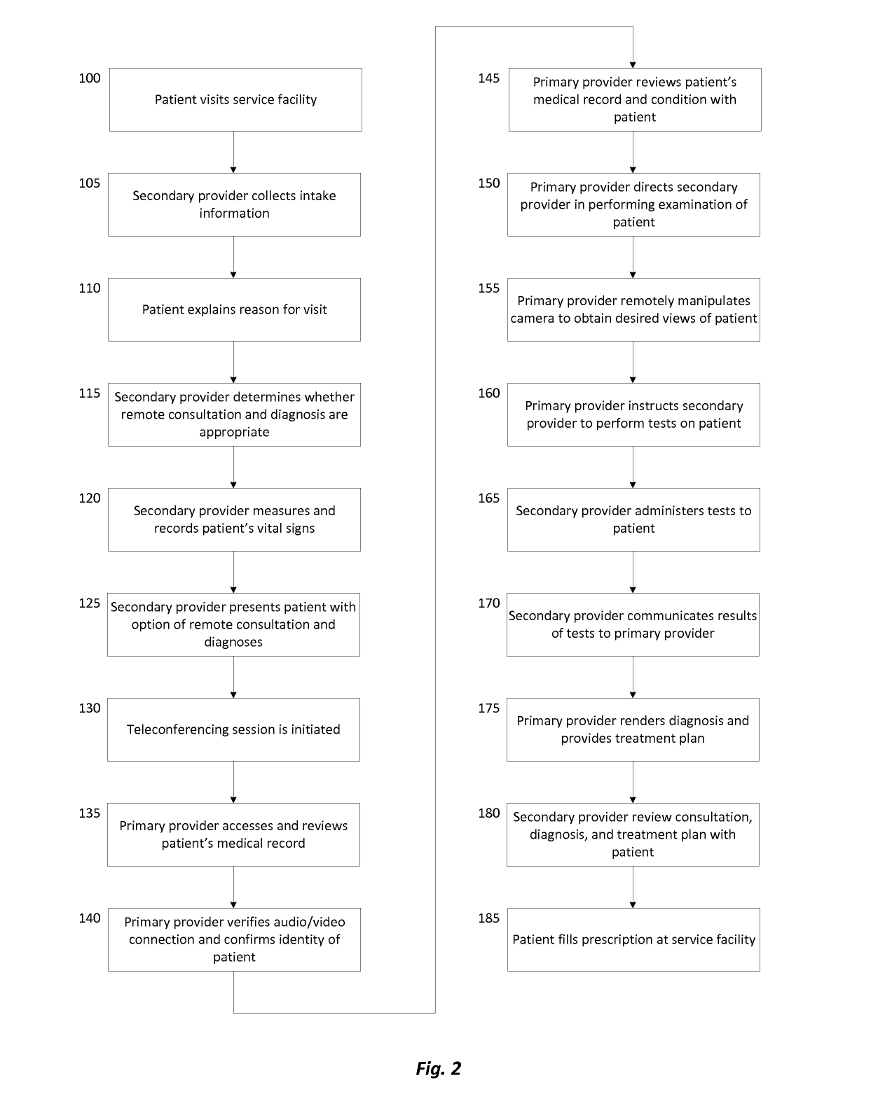

Referring to FIG. 2, a flow diagram illustrating an exemplary method for providing remote medical consultation and diagnosis in accordance with the present disclosure is shown. The method will now be described in detail in conjunction with the system 10 shown in FIG. 1.

At step 100 of the exemplary method, a patient suffering from an injury or symptoms of illness (hereinafter collectively referred to as “a condition”) may visit the service facility 12 for a medical consultation and diagnosis. As previously stated, the service facility 12 may be, or may be located within, a pharmacy, a local health clinic, or another establishment that may be located in relatively close proximity to the patient's home or place of work, for example.

Upon the patient's arrival at the service facility 12, a secondary healthcare provider or another individual may, at step 105 of the exemplary method, collect certain intake information from the patient. Such information may include, but is not limited to, the patient's name, home address, phone number, e-mail address, emergency contact, insurance provider, primary healthcare provider (e.g., family doctor), proof of identity, and the like. The intake information may be used to create a patient medical record which may be stored in an electronic database or other record-keeping system. If the patient has an existing medical record, such as may have been created during a previous visit to the service facility 12 or to an affiliated facility, the secondary healthcare provider or other individual may simply verify some or all of the information in the existing medical record with the patient and may update the medical record as necessary.

At step 110 of the exemplary method, the patient may explain the reason for his or her visit to the secondary healthcare provider. For example, the patient may describe and/or show to the secondary healthcare provider the condition that he or she is suffering from. Exemplary conditions that the patient may present with include, but are not limited to, coughing, sneezing, fever, aches and pains, insomnia, fatigue, decreased appetite, vertigo, blurred vision, gastrointestinal irregularities, various physical injuries, etc.

After the patient has communicated the reason for his or her visit to the secondary healthcare provider, the secondary healthcare provider may, at step 115 of the exemplary method, determine whether remote medical consultation and diagnosis are appropriate for the patient. For example, if the patient's condition does not appear to be particularly serious and/or does not require immediate, in-person medical intervention, the secondary healthcare provider may determine that remote medical consultation and diagnosis are appropriate. However, if the secondary healthcare provider determines that the patient's condition is serious and/or does require immediate, in-person medical intervention, the secondary healthcare provider may refer the patient to a hospital or critical care facility, may contact emergency medical services (e.g., 911), may refer the patient to an on-site primary healthcare provider if one is present, and/or may intervene him/herself to mitigate the patient's condition.

If the secondary healthcare provider determines that the patient's condition can be appropriately addressed using remote medical consultation and diagnosis, the secondary healthcare provider may, at step 120 of the exemplary method, measure the patient's vital signs. For example, the secondary healthcare provider may use one or more of the pulse oximeter 29, sphygmomanometer 31, thermometer 33, and scale 37 to measure the patient's blood oxygen saturation, blood pressure, temperature, and weight and height, respectively. The measured vital signs may be automatically or manually recorded in the patient's medical record (described above) along with a description of the patient's condition.

At step 125 of the exemplary method, the secondary healthcare provider may ask the patient if he or she would like to obtain a remote medical consultation and diagnosis. This may include the secondary healthcare provider providing the patient with an explanation of the remote consultation and diagnosis process. If the service facility 12 staffs one or more primary healthcare providers, the secondary healthcare provider may offer the patient a choice between obtaining an in-person medical consultation and diagnosis from an on-site primary healthcare provider or, alternatively, obtaining a remote medical consultation and diagnosis from an off-site primary healthcare provider. For example, in a typical situation, the secondary healthcare provider may offer the patient a choice between waiting for an in-person medical consultation and diagnosis with an on-site primary healthcare provider who is currently busy seeing another patient, or obtaining a remote medical consultation and diagnosis from an off-site primary healthcare provider without waiting. In some cases, the patient may have to wait for either an on-site or remote medical consultation and diagnosis, such as if the on-site primary healthcare provider(s) at the service facility 12 is busy and the first teleconferencing station 16 is in use. In other cases, the service facility 12 may not staff any primary healthcare providers, in which case the patient would only have the option of obtaining remote medical consultation and diagnosis at the service facility 12.

If the patient elects to obtain a remote medical consultation and diagnosis from an off-site primary healthcare provider, the secondary healthcare provider may, at step 130 of the exemplary method, use the first teleconferencing station 16 at the service facility 12 to initiate a teleconferencing session with the second teleconferencing station 18 at the provider facility 14. The secondary healthcare provider and the patient may thereby be placed in two-way audio/video communication with a primary healthcare provider at the provider facility 14. Particularly, audio and video of a primary healthcare provider at the provider facility 14 may be captured by the microphone 22b and the camera 20b of the second teleconferencing station 18 and may be presented via the speaker 26a and the display 24a of the first teleconferencing station 16, respectively, and audio and video of the secondary healthcare provider and the patient at the service facility 12 may be captured by the microphone 22a and the camera 20a of the first teleconferencing station 16 and may be presented via the speaker 26b and the display 24b of the second teleconferencing station, respectively.

Upon initiation of the teleconferencing session, the primary healthcare provider may, at step 135 of the exemplary method, access and review the patient's electronically-stored medical record to gain a general understanding of the patient's physical status and condition. Alternatively, the primary healthcare provider may access and review patient's medical record prior to initiation of the teleconferencing session, such as upon prior notification from the secondary healthcare provider.

At step 140 of the exemplary method, the primary healthcare provider may ask the patient if he or she can see and hear the primary healthcare provider clearly, and may also ask the patient if he or she has any preliminary questions that the primary healthcare provider may be able to address. The primary healthcare provider may further verify the patient's name, date of birth, and/or other identifying information to confirm that the primary healthcare provider is looking at the correct medical record.

At step 145 of the exemplary method, the primary healthcare provider may review the patient's medical record with the patient, including the patient's vital signs (previously measured by the secondary healthcare provider as described above) and the condition for which the patient is seeking consultation and diagnosis. For example, the patient may describe and/or show his or her symptoms in detail to the primary healthcare provider.

At step 150 of the exemplary method, the primary healthcare provider and the secondary healthcare provider may proceed with an examination of the patient. Particularly, the secondary healthcare provider may, at the direction of the primary healthcare provider, use the diagnostic tools 30 and/or the examination tools 32 to capture video and/or audio of relevant portions of the patient's anatomy. For example, if the patient is complaining of a sore throat, the primary healthcare provider may instruct the secondary healthcare provider to use the video laryngoscope 36 to capture video of the patient's throat. As described above, such video may be presented to the primary healthcare provider on the display 24b of the second teleconferencing station 18 or on a separate display at the provider facility 14. The captured video may also be simultaneously presented to the patient and the secondary healthcare provider on the display 24a of the first teleconferencing station 16 or on a separate display at the service facility 12. The primary healthcare provider and the patient may thereby be simultaneously provided with the same view of the patient's anatomy so that the primary healthcare provider may clearly explain relevant observations to the patient (e.g., areas of visible inflammation in the patient's throat).

In another example, the primary healthcare provider may instruct the secondary healthcare provider to use the digital stethoscope 35 to capture audio of the patient's heart and/or lung sounds during auscultation. Such audio may be played through the speaker 26b of the second teleconferencing station 18 and may also be played through the speaker 26a of the first teleconferencing station 16. It will be appreciated that the other diagnostic tools 30 and the examination tools 32 may be implemented in a similar manner at the discretion and direction of the primary healthcare provider to examine the patient as necessary.

In addition to instructing the secondary healthcare provider to capture audio and video of the patient using the diagnostic tools 30 and the examination tools 32, the primary healthcare provider may, at step 155 of the exemplary method, also manipulate the position, orientation, and/or zoom level of the camera 20a in order to obtain a desired view of the patient. Such manipulation may be achieved through manipulation of the input device 28 of the second teleconferencing station 18, which may cause the camera 20a to move and/or zoom in a selective, corresponding manner.

Still further, it is contemplated that the primary healthcare provider may enlist another healthcare professional (e.g., another primary or secondary healthcare provider) located at the provider facility 14 to join or assist the primary healthcare provider in performing the examination of the patient via the first teleconferencing station 16. For example, if the patient expresses or exhibits a dermatologic symptom and the primary healthcare provider does not possess expertise in dermatology, the primary healthcare provider may ask a dermatologist who is located at the provider facility 13 to participate in the examination.

Based on the examination of the patient, the primary healthcare provider may, at step 160 of the exemplary method, instruct the secondary healthcare provider to perform certain tests on the patient as may be appropriate. For example, if the patient is complaining of a sore throat and the examination of the patient yielded evidence of strep throat, the primary healthcare provider may instruct the secondary healthcare provider to administer a conventional strep throat test to the patient. It will be appreciated by those or ordinary skill in the art that many other tests may be deemed appropriate depending on the condition and examination of the patient.

At step 165 of the exemplary method, the secondary healthcare provider may administer any tests that were ordered by the primary healthcare provider. While the tests are administered and the results of such tests are processed, the teleconferencing session with the primary healthcare provider may be maintained or may be temporarily suspended.

Once the results of the above-described tests are available (i.e., if any tests were ordered by the primary healthcare provider may), the secondary healthcare provider may, at step 170 of the exemplary method, communicate the results of such tests to the primary healthcare provider. In the above example, for instance, the secondary healthcare provider may communicate a negative or positive indication of strep throat for the patient.

At step 175 of the exemplary method, the primary healthcare provider may use some or all of the patient's medical record, observations made during examination of the patient, and results of any tests that may have been administered to the patient in order to render a diagnosis. The primary healthcare provider may communicate the diagnosis to the patient and may also provide the patient with a treatment plan which may include one or more prescription medication regimens. The primary healthcare provider may further address any questions that the patient may have regarding the examination, the diagnosis, and/or the treatment plan. The teleconferencing session may then be concluded.

After the conclusion of the teleconferencing session, the secondary healthcare provider may, at step 180 of the exemplary method, review the consultation and diagnosis with the patient, including any instructions and/or medication regimens that were provided by the primary healthcare provider. The secondary healthcare provider may also forward a summary of the patient's consultation and diagnosis to the patient's primary care physician. The secondary healthcare provider may also collect payment from the patient if any out-of-pocket payment is due.

If the service facility is a pharmacy or includes an on-site pharmacy, the patient may, at step 185 of the exemplary method, fill any prescriptions that were provided by the primary healthcare provider at the service facility 12. The patient is thereby spared the inconvenience of having to travel to another location to fill his or her prescriptions.

Alternative embodiments of the system 10 and the method described above are contemplated in which the service facility 12, including the secondary healthcare provider and the first teleconferencing station 16, are entirely omitted. Instead, the patient may establish a teleconferencing session with the primary healthcare provider using a smart phone, tablet, laptop, desktop, or any other personal computing/communication platform that is equipped with a camera, a display, a microphone, a speaker, and/or a text input means. The patient may thereby obtain a remote consultation and diagnosis directly from the primary healthcare provider from any convenient location (e.g., home, work, etc.) without having to travel to a service facility and without the assistance of a secondary healthcare provider, though it is contemplated that a secondary healthcare provider (e.g., a home nurse) may be present at the patient's location and may assist in performing the remote consultation and diagnosis via the patient's computing/communication platform.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

The present disclosure is not to be limited in scope by the specific embodiments described herein. Indeed, various other embodiments of and modifications to the present disclosure, in addition to those described herein, will be apparent to those of ordinary skill in the art from the foregoing description and accompanying drawings. These other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method for providing remote medical consultation and diagnosis, the method comprising:
a patient visiting a service facility where a secondary healthcare provider is located;
establishing a teleconferencing session between a first teleconferencing station located in the service facility and a second teleconferencing station located in a provider facility that is remote from the service facility, a primary healthcare provider being present at the provider facility; and
the primary healthcare provider performing an examination on the patient using audio and video that are captured at the first teleconferencing station and transmitted to the second teleconferencing station.

2. The method of claim 1, further comprising the secondary healthcare provider collecting intake information from the patient prior to establishing the teleconferencing session.

3. The method of claim 1, further comprising the secondary healthcare provider measuring vital signs of the patient prior to establishing the teleconferencing session.

4. The method of claim 1, wherein the examination comprises the primary healthcare provider instructing the secondary healthcare provider to use examination tools associated with the first teleconferencing station to capture desired video of the patient's anatomy.

5. The method of claim 4, further comprising presenting the captured video at the first teleconferencing station and at the second teleconferencing station simultaneously.

6. The method of claim 1, further comprising the primary healthcare provider instructing the secondary healthcare provider to perform a test on the patient at the service facility.

7. The method of claim 1, further comprising the primary healthcare provider using one or more of measured vital signs of the patient, observations of the patient made during the examination, and results of tests that are performed on the patient by the secondary healthcare provider to render a diagnosis for the patient.

8. The method of claim 7, further comprising the primary healthcare provider providing the patient with a treatment regimen based on the diagnosis.

9. The method of claim 7, further comprising the primary healthcare provider providing the patient with a prescription for medication, and the patient filling the prescription at the service facility.

10. The method of claim 1, further comprising the secondary healthcare provider sending a summary of the patient's consultation and diagnosis to a primary care physician of the patient.

11. A system for providing remote medical consultation and diagnosis, the system comprising:
a first teleconferencing system located in a service facility where a secondary healthcare provider and a patient are located, the first teleconferencing system comprising:
an examination tool to capture video of the patient's anatomy; and
a computer processor configured to execute computer instructions to:
initiate a teleconferencing session between the first teleconferencing system and a second teleconferencing system;
receive, from a primary healthcare provider, directions for the secondary healthcare provider to examine the patient using the examination tool; and
transmit, to the primary healthcare provider, results of the examination; and
a second teleconferencing system located in a provider facility where the primary healthcare provider is located, the second teleconferencing system comprising:
a computer processor configured to execute computer instructions to:
display medical records associated with the patient for review by the primary healthcare provider;
transmit, per a request from the primary healthcare provider, directions to the secondary healthcare provider to examine the patient;
receive, from the secondary healthcare provider, results of the examination; and
transmit, to the secondary healthcare provider, a treatment plan based at least in part on the results.

12. The system of claim 11, wherein the computer processor of the first teleconferencing system is further configured to collect intake information from the patient prior to initiating the teleconferencing session.

13. The system of claim 11, wherein the computer processor of the first teleconferencing system is further configured to receive vital signs of the patient measured by the secondary healthcare provider prior to establishing the teleconferencing session.

15. The system of claim 11, wherein the computer processors of the first and second teleconferencing systems are further configured present the captured video at the first teleconferencing station and at the second teleconferencing station simultaneously.

16. The system of claim 11, wherein the computer processor of the first teleconferencing system is further configured further comprising transmitting an instruction from the primary healthcare provider instructing the secondary healthcare provider to perform a test on the patient at the service facility.
